(19) United States
(12) Patent Application Publication
(10) Pub. No.: US 2023/0296429 A1
(43) Pub. Date: Sep. 21, 2023

(54) GLAZING WITH A REUSABLE VIBRATION SENSOR

(71) Applicant: AGC GLASS EUROPE, Louvain-la-Neuve (BE)

(72) Inventors: Arnaud ISERENTANT, Vieux-Genappe (BE); Hermann LELONG, Gosselies (BE)

(73) Assignee: AGC GLASS EUROPE, Louvain-la-Neuve (BE)

(21) Appl. No.: 18/041,585

(22) PCT Filed: Aug. 19, 2021
(86) PCT No.: PCT/EP2021/073026

§ 371 Date: Feb. 14, 2023

(30) Foreign Application Priority Data
Aug. 21, 2020 (EP) 20192215.0

(51) Int. Cl. G01H 11/08

(52) U.S. Cl. CPC G01H 11/08

(57) ABSTRACT

A glazing including a reusable sensing device for detecting vibration of the glazing. The reusable sensing device includes at least one vibration sensor able to capture and to convert a vibration of the glazing into an analogic signal, at least one operational amplifier able to process the analogic signal, at least one window comparator able to determine if the analogic signal is below a minimal threshold or above a maximal threshold, a microcontroller able to convert the analogic signal received from each of the at least one operational amplifier into digital data, the microcontroller being able to be activated by each of the at least one window comparator, and an SR latch with an S input connected to each of the at least one window comparator, an R input connected to the microcontroller, and a Q output connected to each of the at least one operational amplifier.

### FIELD OF THE INVENTION

The present invention relates to a glazing equipped with a sensing device, more particularly to a glazing comprising a reusable sensing device for detecting vibration of the glazing.

### BACKGROUND OF THE INVENTION

Nowadays glazings equipped with a sensing device are highly used, especially in the automotive where they allow to analyse impacts on an automotive glazing (such as in US20100163675 or WO2019101884). Based on the analysis of the vibration of the glazing due to an impact, the sensing device permits to determine if the impact may have cause a crack on the glazing itself.

Such sensing device preferably has a reduced power consumption. One way to reduce the power consumption is to switch on the sensing device only when necessary, meaning only when it has to register an impact on the glazing. In order to do so, the sensing device must be able to discriminate usual vibration (due for example to the displacement of the vehicle on which it is fixed or to the closing of a door of the vehicle on which it is fixed) and unusual vibration due to an impact on the glazing. EP19187269 proposes the use of an accelerometer combined to the sensing device in order to know when the sensing device has to be switched on or off.

Such sensing device usually comprises a vibration sensor and a microcontroller to convert the analogic signal from the vibration sensor to a digital signal. In order to reduce the power consumption, the microcontroller is asleep most of the time, but the microcontroller has to record the analogic signal from the vibration sensor when the glazing is vibrating due to an impact on the glazing. A window comparator is usually used for this purpose. The window comparator checks the analogic signal coming from the vibration sensor. If the analogic signal is below a minimal threshold or above a maximal threshold, the window comparator outputs a logical signal which triggers the microcontroller. The analogic signal is also sent to a pre-processing stage before reaching the μC for the analog to digital conversion. This type of processing stage is generally based on operational amplifiers. However, as the analogical signal varies rapidly, the amplifier needs to have a high slew rate and a large bandwidth. The slew rate of an amplifier is the maximum rate at which an amplifier can respond to an abrupt change of input level. Such amplifier has an important static consumption when active.

So there is a need to find a solution in order to use such amplifiers, which are able to follow the signal specifications, while respecting the consumption constraints.

### SUMMARY OF THE INVENTION

The present invention concerns a glazing comprising a reusable sensing device for detecting vibration of the glazing. The reusable sensing device comprises a vibration sensor able to capture and to convert a vibration of the glazing into an analogic signal. The reusable sensing device also comprises an operational amplifier able to process the analogic signal. The reusable sensing device also comprises a window comparator able to determine if the analogic signal is below a minimal threshold or above a maximal threshold. The reusable sensing device also comprises a microcontroller able to convert the analogic signal received from the operational amplifier into digital data, the microcontroller being able to be activated by the window comparator. The reusable sensing device is characterized in that it also comprises an SR latch with the S input connected to the window comparator, the R input connected to the microcontroller and the Q output connected to the operational amplifier.

The present invention also concerns a reusable sensing device for detecting vibration of a glazing as described here above.

### BRIEF DESCRIPTION OF THE DRAWINGS

The invention will now be described further, by way of examples, with reference to the accompanying drawings, wherein like reference numerals refer to like elements in the various figures. These examples are provided by way of illustration and not of limitation. The drawings are a schematic representation and not true to scale. The drawings do not restrict the invention in any way. More advantages will be explained with examples.

FIG. 1 illustrates a general embodiment of the reusable sensing device as claimed by the present patent application.

FIG. 2 illustrates a typical analogic signal generated by an impact on a glazing.

FIG. 3a illustrates an embodiment of the reusable sensing device as claimed by the present patent application, with the feature of an additional filter for each vibration sensor.

FIG. 3b illustrates an embodiment of the reusable sensing device as claimed by the present patent application, with the feature of two additional filters for each vibration sensor.

FIG. 4 illustrates an embodiment of the reusable sensing device as claimed by the present patent application, with the feature of an additional switch.

FIG. 5 illustrates an embodiment of the reusable sensing device as claimed by the present patent application, with multiple vibration sensors.

### DETAILED DESCRIPTION OF ILLUSTRATIVE EMBODIMENTS

The present invention will be described with respect to particular embodiments and with reference to certain drawings but the invention is not limited thereto but only by the claims.

While some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

The present invention proposes a glazing comprising a reusable sensing device for detecting vibration of the glazing. The glazing can be but is not restricted to an automotive glazing, more specifically a windshield of an automotive vehicle. An automotive vehicle includes cars, vans, lorries, motorbikes, buses, trams, trains, airplanes, helicopters and the like. The glazing can be made of glass, more specifically soda-lime-silica type glass, alumino-silicate, boro-silicate. The glazing can be made of an association of glass and plastics.

Reusable sensing device means that the sensing device can be removed from the glazing to be fixed non-permanently to another glazing. This way the sensing device can be reused in case the glazing has to be replaced.

The reusable sensing device comprises a vibration sensor able to capture and to convert a vibration of the glazing into an analogic signal. The vibration can result from an impact on the glazing. The vibration sensor could for example be a piezoelectric bender, which converts mechanical effort into electrical signal. The reusable sensing device can comprise more than one vibration sensor. For example, the reusable sensing device can comprise two vibration sensors, or three vibration sensors allowing triangulation of the signal.

The reusable sensing device also comprises an operational amplifier able to process the analogic signal. The reusable sensing device comprises the same quantity of operational amplifier than of vibration sensor.

The reusable sensing device also comprises a window comparator able to determine if the analogic signal is below a minimal threshold or above a maximal threshold. These thresholds are determined to discriminate a signal of interest from noise. If the analogic signal is below a minimal threshold or above a maximal threshold, then the reusable sensing device is set in active mode. Otherwise the reusable sensing device is set in sleep mode. The reusable sensing device comprises the same quantity of window comparator than of vibration sensor.

The reusable sensing device also comprises a microcontroller. The microcontroller converts the analogic signal received from the operational amplifier into digital data. The microcontroller is activated by the window comparator once the analogic signal is below the minimal threshold or above the maximal threshold.

The reusable sensing device also comprises an SR (Set/Reset) latch. In electronics, a latch is a device which stores a single bit (binary digit) of data: one of its two states represents an activated state and the other represents an inactivated state. Such data storage can be used for storage of state, and such a circuit is described as sequential logic in electronics.

An SR latch works independently of control signals and relies only on the state of the S and R inputs. It can be constructed from a pair of cross-coupled NOR or NAND logic gates. When the set line of an SR latch is activated, the Q output is activated. The feedback mechanism, however, means that the Q output will remain activated, even when the S input goes inactivated. This is how the latch serves as a memory device. Conversely, when the reset line is activated, the Q output is inactivated, effectively resetting the latch's “memory”. When both inputs are inactivated, the latch “latches”—it remains in its previously set or reset state.

For the present invention, the S input is connected to the window comparator. So when the analogic signal is below a minimal threshold or above a maximal threshold, the window comparator activates the SR latch through its S input.

The R input of the SR latch is connected to the microcontroller, meaning that only the microcontroller can reset the SR latch through its R input.

The Q output of the SR latch is connected to the operational amplifier. So when the SR latch is activated, it enables the operational amplifier to process the analogic signal received from the vibration sensor.

One interest of the invention is to keep the consumption as low as possible in both sleep and active modes, as the microcontroller, the SR latch and the operational amplifier are only triggered on request of the windows comparator. The use of an SR latch allows to add a shutdown option to the operational amplifier which considerably decrease the consumption.

An interest of the invention is also to have a parallel track: the windows comparator and the microcontroller on a first track, the windows comparator, the SR latch, the operational amplifier and the microcontroller on the second track. This way, the windows comparator triggers the microcontroller which takes a certain time to be activated. In parallel the windows comparator also triggers the SR latch and de facto the operational amplifier which will then send the processed analogic signal to the microcontroller. In the meantime the microcontroller is ready to acquire such processed analogic signal.

The reusable sensing device can further comprise filters able to pre-process the analogic signal. Filters could be used to set an offset to the analogic signal to adapt to the requirements of the microcontroller or to apply a high pass filter and/or a low pass filter to the raw signal from the vibration sensor.

According to one embodiment of the present invention, the reusable sensing device can further comprise a switch connected between the window comparator and the S input of the SR latch. This switch is controlled by the microcontroller. This allows for the microcontroller to stay master of the system, meaning for the microcontroller to keep the SR latch inactivated even if the windows comparator triggers the SR latch. Such embodiment can be useful in case of multiple impacts on the glazing, for example due to hail.

According to one embodiment of the present invention, the acquisition duration by the microcontroller is comprised between 2 ms and 10 ms, preferably between 3 ms and 6 ms, more preferably between 4 ms and 5 ms.

According to another embodiment of the present invention, the acquisition duration by the microcontroller is stopped once the window comparator receives no more signal from the vibration sensor for at least 4 ms, preferably at least 3 ms, more preferably at least 2 ms.

The present invention also proposes a reusable sensing device for detecting vibration of a glazing, as described previously.

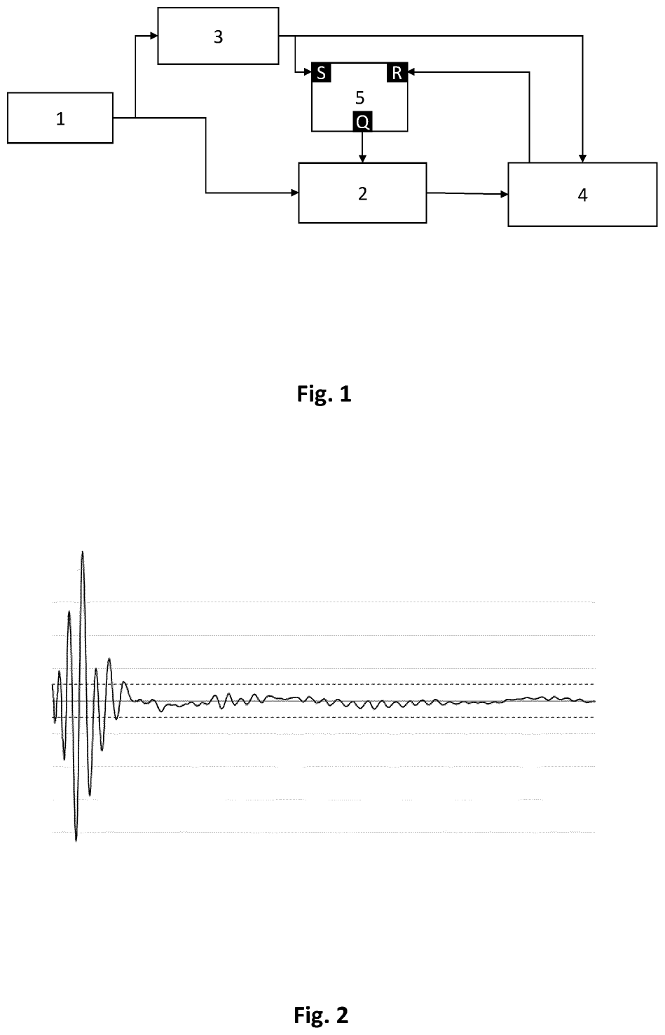

Referring to FIG. 1 which represents schematically a reusable sensing device according to the invention, a vibration sensor (1) captures and converts a vibration of a glazing on which the vibration sensor is fixed, into an analogic signal.

This analogic signal is transmitted to an operational amplifier (2) able to process the analogic signal.

This analogic signal is also transmitted to a window comparator (3). The windows comparator (3) analyses the analogic signal and outputs a logical signal, meaning either an inactivated state or an activated state. If the analogic signal is below a minimal threshold or above a maximal threshold, the window comparator (3) outputs an activated state which triggers a microcontroller (4). Otherwise the window comparator (3) outputs an inactivated state.

As shown on FIG. 2, the analogic signal (solid line) transmitted to the window comparator (3) varies rapidly. The window comparator (3) therefore outputs a series of activated and inactivated states, following the analogic signal crossing either the minimal threshold or the maximal threshold (both dotted lines).

Back to FIG. 1, when the analogic signal received by the window comparator (3) is below a minimal threshold or above a maximal threshold, the window comparator (3) outputs an activated state. It therefore triggers an SR latch (5) through its S input.

As the SR latch (5) is activated, it allows the operational amplifier (2) to operate, therefore to process the analogic signal, through its Q output. This processed analogic signal is then transmitted to the microcontroller (4), which has been triggered meanwhile by the window comparator (3).

The microcontroller (4) converts the processed analogic signal received from the operational amplifier (2) into digital data. Once the microcontroller (4) has finished to acquire the signal, it resets the SR latch (5) through its R input. The SR latch (5) therefore deactivates the operational amplifier (2) through its Q output.

Only the window comparator (3) is able to set the SR latch (5). And only the microcontroller (4) is able to reset the SR latch (5).

If the analogic signal falls below the maximal threshold and above the minimal threshold, the window comparator (3) outputs an inactivated state to the S input of the SR latch (5). However, as the SR latch (5) can only be reset by the microcontroller (4), the SR latch (5) maintains enabled the operational amplifier (2) by keeping its Q output unchanged. The microcontroller (4) still acquires the processed signal sent by the operational amplifier (2).

The reset of the SR latch (5) can only be done by the microcontroller (4). The microcontroller (4) can be programmed to stop acquiring after a dedicated amount of time, for example after 5 milliseconds of acquisition. The microcontroller (4) can also be programmed to stop acquisition once it receives no more analogic signal from the window comparator (3) for a specific duration, for example for 2 milliseconds.

Once the microcontroller (4) has finished acquisition of the processed analogic signal, it resets the SR latch (5) through its R input. The SR latch (5) therefore stops the operational amplifier (2) through its Q output. The reusable sensing device is back to its original state, waiting to be activated by the window comparator (3).

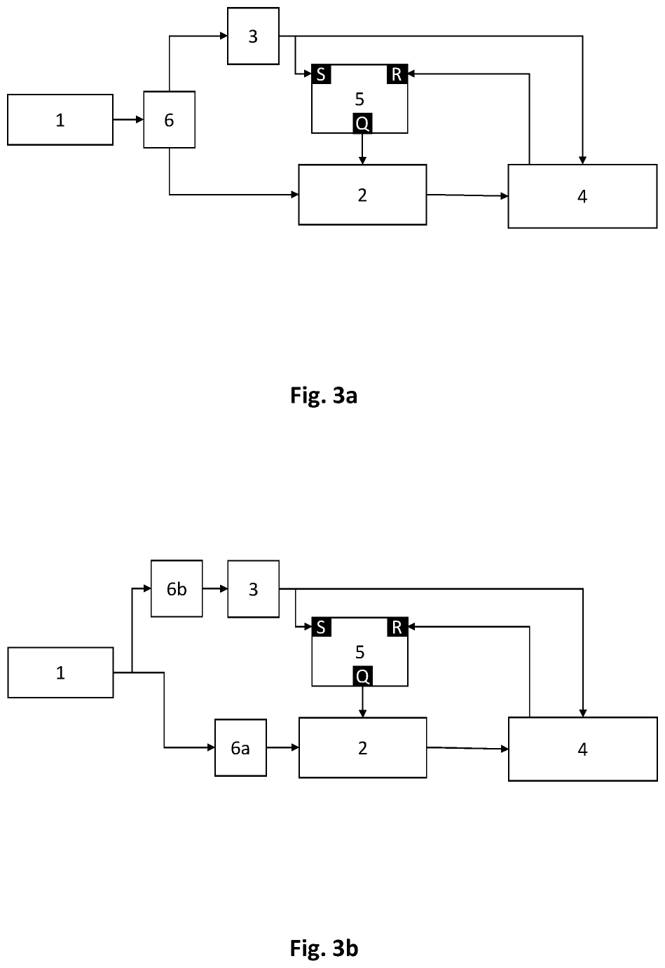

As shown on FIG. 3a, the reusable sensing device can further comprise at least one filter (6) placed after the vibration sensor (1) and before the operational amplifier (2) and the window comparator (3). This filter (6) can be used to pre-process the analogic signal from the vibration sensor (1). It can be used to set an offset to the analogic signal to adapt to the requirements of the microcontroller (4), for example if the analogic signal can be positive or negative and if the microcontroller (4) only accepts positive values. This filter (6) can also be used to apply a high pass filter and/or a low pass filter to the raw signal from the vibration sensor (1).

As shown on FIG. 3b, the reusable sensing device can further comprise at least two filters (6a and 6b) respectively placed between the vibration sensor (1) and the window comparator (3) and the vibration sensor (1) and the operational amplifier (2). These filters (6a and 6b) can be used to pre-process the analogic signal from the vibration sensor (1). They can be used to set an offset to the analogic signal to adapt to the requirements of the microcontroller (4), for example if the analogic signal can be positive or negative and if the microcontroller (4) only accepts positive values. These filters (6a and 6b) can also be used to apply a high pass filter and/or a low pass filter to the raw signal from the vibration sensor (1). For example, the first filter (6a) can be used to filter frequencies due to untimely and unwanted triggering of the window comparator (3) due to slamming door while the second filter (6b) can be used to restrain the analogic signal to the frequency domain of interest.

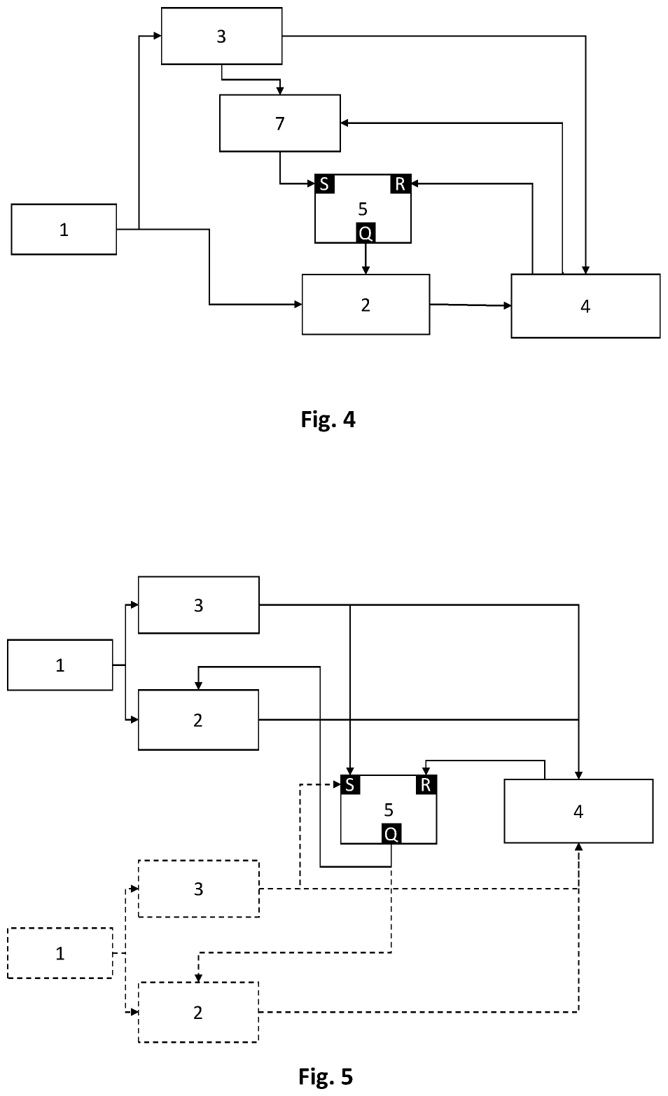

As shown on FIG. 4, the reusable sensing device can further comprise a switch (7) connected between the window comparator (3) and the S input of the SR latch (5). This switch (7) is controlled by the microcontroller (4). This connection prevails on the connection between the windows comparator (3) and the SR latch (5), so that the microcontroller can force the SR latch (5) to stay inactivated even if the windows comparator (3) triggers the SR latch (5).

As shown on FIG. 5, the reusable sensing device can comprise more than one vibration sensor (1). In this case, the reusable sensing device comprise the same quantity of operational amplifier (2) and of comparator window (3) than of vibration sensor (1). But the reusable sensing device comprise still one microcontroller (4) and one SR latch (5). The additional operational amplifiers (2) and window comparators (3) are connected as previously explained to the microcontroller (4) and the SR latch (5).

While the invention has been illustrated and described in detail in the drawings and foregoing description, such illustration and description are to be considered illustrative or exemplary and not restrictive. The foregoing description details certain embodiments of the invention. It will be appreciated, however, that no matter how detailed the foregoing appears in text, the invention may be practiced in many ways. The invention is not limited to the disclosed embodiments.

1: A glazing comprising a reusable sensing device for detecting vibration of the glazing, the reusable sensing device comprising:
at least one vibration sensor able to capture and to convert a vibration of the glazing into an analogic signal;
at least one operational amplifier able to process the analogic signal;
at least one window comparator able to determine if the analogic signal is below a minimal threshold or above a maximal threshold;
a microcontroller able to convert the analogic signal received from each of the at least one operational amplifier into digital data, the microcontroller being able to be activated by each of the at least one window comparator; and
an SR latch with an S input connected to each of the at least one window comparator, an R input connected to the microcontroller and a Q output connected to each of the at least one operational amplifier.

2: The glazing according to claim 1, wherein the reusable sensing device further comprises at least one filter able to pre-process the analogic signal, wherein the at least one filter is positioned after the at least one vibration sensor and before both the at least one operational amplifier and the at least one window comparator.

3: The glazing according to claim 1, wherein the reusable sensing device further comprises a first filter and a second filter, both being able to pre-process the analogic signal, wherein the first filter is positioned after the at least one vibration sensor and before the at least one operational amplifier, and wherein the second filter is positioned after the at least one vibration sensor and before the at least one window comparator.

4: The glazing according to claim 1, wherein the reusable sensing device further comprises at least one switch connected between each of the at least one window comparator and the S input of the SR latch, wherein the at least one switch is controlled by the microcontroller.

5: The glazing according to claim 1, wherein an acquisition duration by the microcontroller is between 2 ms and 10 ms.

6: The glazing according to claim 1, wherein an acquisition duration by the microcontroller is stopped once each of the at least one window comparator receives no more signal from the at least one vibration sensor for at least 4 ms.

7: A reusable sensing device for detecting vibration of a glazing, the reusable sensing device comprising:
at least one vibration sensor able to capture and to convert a vibration of the glazing into an analogic signal;
at least one operational amplifier able to process the analogic signal;
at least one window comparator able to determine if the analogic signal is below a minimal threshold or above a maximal threshold;
a microcontroller able to convert the analogic signal received from each of the at least one operational amplifier into digital data, the microcontroller being able to be activated by each of the at least one window comparator; and
an SR latch with an S input connected to each of the at least one window comparator, an R input connected to the microcontroller and a Q output connected to each of the at least one operational amplifier.

8: The reusable sensing device according to claim 7, further comprising at least one filter able to pre-process the analogic signal, wherein the at least one filter is positioned after the at least one vibration sensor and before both the at least one operational amplifier and the at least one window comparator.

9: The reusable sensing device according to claim 7, further comprising a first filter and a second filter, both being able to pre-process the analogic signal, wherein the first filter is positioned after the at least one vibration sensor and before the at least one operational amplifier, and wherein the second filter is positioned after the at least one vibration sensor and before the at least one window comparator.

10: The reusable sensing device according to claim 7, further comprising at least one switch connected between each of the at least one window comparator and the S input of the SR latch, wherein the at least one switch is controlled by the microcontroller.

11: The reusable sensing device according to claim 7, wherein an acquisition duration by the microcontroller is between 2 ms and 10 ms.

12: The reusable sensing device according to claim 7, wherein an acquisition duration by the microcontroller is stopped once each of the at least one window comparator receives no more signal from the at least one vibration sensor for at least 4 ms.

13: The glazing according to claim 1, wherein an acquisition duration by the microcontroller is between 3 ms and 6 ms.

14: The glazing according to claim 1, wherein an acquisition duration by the microcontroller is stopped once each of the at least one window comparator receives no more signal from the at least one vibration sensor for at least 3 ms.

15: The reusable sensing device according to claim 7, wherein an acquisition duration by the microcontroller is between 3 ms and 6 ms.

16: The reusable sensing device according to claim 7, wherein an acquisition duration by the microcontroller is stopped once each of the at least one window comparator receives no more signal from the at least one vibration sensor for at least 3 ms.
